(19) United States
(12) Patent Application Publication
(10) Pub. No.: US 2013/0252020 A1
(43) Pub. Date: Sep. 26, 2013

(54) Electro-Depositing Metal Layers of Uniform Thickness

(71) Applicant: George Hradil, Barrington, RI (US)

(72) Inventor: George Hradil, Barrington, RI (US)

(21) Appl. No.: 13/991,758

(22) PCT Filed: Dec. 6, 2011
(86) PCT No.: PCT/US11/63457

§ 371 Date: Jun. 5, 2013

Related U.S. Application Data
(60) Provisional application No. 61/420,381, filed on Dec. 7, 2010.

(51) Int. Cl. C25D 21/12; B32B 15/04

(52) U.S. Cl. CPC C25D 21/12; B32B 15/043
USPC 428/642; 205/261; 205/239; 205/241; 205/240; 205/242; 205/244; 205/246; 205/247; 205/250; 205/251; 205/252; 205/255; 205/238; 428/663

(57) ABSTRACT

The invention is an apparatus and method for forming highly uniform layers of metal on a substrate by electro-deposition. The substrate is electroplated in a bath composed of a quiescent (i.e., no external agitation) electrolyte solution using an effective constant current density carefully selected to match the chemical composition of the electrolyte.

### FIELD OF THE INVENTION

The invention is in the field of electroplating in general, and more particularly to thin film photovoltaic cell and semi-conductor wafer electro-deposition, as well as in other applications in which uniform layers of the plated metal or metal alloy are required.

### BACKGROUND OF THE INVENTION

The current initiative to implement solar photovoltaic power generation on a large scale has created interest in low cost methods of photovoltaic cell (PV cell) fabrication. Traditionally, PV cells have been made from crystalline silicon wafers with a thickness ranging from 150-350 microns. Silicon-based PV cells are expensive because of the amount of raw material required and the necessity of removing impurities and defects from the silicon. In addition, silicon has a band gap energy of 1.1 eV, which is at the lower end of the range of effectiveness for PV cells. Thin-film semi-conducting alloys, which are fabricated from two or more semiconductor layers having different characteristics so as to create an electric potential and resultant current, have been explored. PV cells made from such alloys are only a few microns thick. The uppermost thin-film layer is commonly referred to as the window or n-type (negative) semi-conducting layer. It absorbs high-energy light and is thin enough to allow light to pass through it to the second, absorbing or p-type (positive) layer below. The p-type layer must have an appropriate band gap to absorb light photons and generate current and voltage. If the band gap is appropriate, less semiconductor material need be used, thereby reducing costs. Group IB, IIIA, VIA transition metal semiconductors are excellent absorber materials for thin film solar cell layers. Particularly good are copper (Cu), indium (In), gallium (Ga), and selenium (Se) or sulfer (S) in combination (known as CIGS(S)); Cu, zinc (Zn), tin (Sn), and Se or S (known as CZTS); and cadmium tellurium (Cd/Te). Alloys of these materials have received considerable attention because of their cost effectiveness. CIGS absorbers have already been employed in solar cells and have yielded conversion efficiencies of almost 20% and absorbers containing cadmium (Cd) and tellurium (Te) are now in large-scale production.

A conventional solar cell of, for example, CIGS semiconductor material, is fabricated on a substrate, typically sheet glass, sheet metal, or an insulating or conducting foil or web. The n-type absorber layer is grown over a conductive, or seed layer which has been previously deposited on the substrate and which acts as the electrical contact to the device. Various conductive layers have been used, for example molybdenum (Mo), tantalum (Ta), tungsten (W), titanium (Ti) and stainless steel. After the absorber layer is grown over the conductive layer, a transparent window layer composed of CdS, ZnO or a CdS/ZnO stack is formed on top of the absorber layer. Metallic grids may be deposited on the window layer to reduce the series resistance of the device.

Thin-film cell absorber layers have been formed by various methods, including RF sputtering, physical vapor deposition (PVD), screen printing, and electroplating. For a brief review of these techniques, see United States Patent Publication 2006-0121701. Electroplating has significant potential as a low cost fabrication method for making thin-film PV cells, but currently cells made by this technique suffer from low efficiency, and substantial technical barriers exist to large scale implementation. Important among these is the lack of compositional and thickness uniformity in the metal alloy absorber layer deposited on the surface of the cell substrate. Conventional electroplating techniques produce an inferior material; during electroplating, the current density and the intensity of electrolyte agitation is non-uniform over the cathode surface resulting in variations in the thickness of the metal(s) deposited. Additionally, the limited electrical conductivity of the first, or seed, layer on the substrate causes higher current densities near the cathodic connections, resulting in higher metal deposit thicknesses in those areas.

Various attempts have been made to improve the electroplating process in order to increase the efficiency of PV cell devices. U.S. Pat. Nos. 5,871,630 and 7,297,868 disclose a two-step process using direct current (DC) in combination with high frequency alternating current to simultaneously co-electro-deposit copper, indium, selenium and appreciable amount of gallium, followed by PVD of additional gallium to adjust the final composition of the deposited film close to the desired, necessary stoichiometric Cu(In₁₋ₓGaₓ)Se₂ ratio. Canadian Patent No. 2002142 discloses an electro-deposition process in which the seed layer is first treated with hydrogen ions to form metallic hydrides, followed by electro-deposition of the absorber layer using a combination of direct and alternating current of a preset frequency. The relative amounts of Cu and In, the frequency and the potential are strictly controlled, and the absorber layer deposited is thereafter treated by chalcogenation. This is said to eliminate voids and other irregularities. Gallium must be deposited in an additional step. United States Patent Publication No. 2006-012170 discloses sequential electroplating of the layers of the absorber material, but does not address the lack of thickness uniformity in the resultant electroplated material. Canadian Patent Application No. 2056609 published 29 May 1993 discloses a one-step electro-deposition method for CuInSe₂ thin-films in which the bath contains the constituent elements of the ternary compound and the stoichiometry and metal ratio is strictly controlled. It does not address the lack of thickness uniformity in the resultant electroplated material. For a discussion relating to the particular problem of non-uniformity of thickness near the edge of the substrate due to the variation in electrolyte levels during electro-deposition see Muftah, J. Mater. Sci.: Mater. Electron. 21: 373-379 (2010) at 376. In sum, foregoing attempts fail to address the problem entirely or fail to ameliorate it.

For information regarding electro-deposition of cadmium and tellurium in the CdTe system for the absorber layer of solar cells see Gregory, J. Electroanalytical Chemistry 293: 85-101 (1990); Lepiller, Thin Solid Films 361-62: 118-122 (2000); Duffy, Electrochimica Acta 45: 3355-65 (2000); and Hsiu, J. Applied Electrochemistry 34: 1057-63 (2004).

### SUMMARY OF THE INVENTION

With the foregoing application in mind, it was discovered that certain modifications to the traditional electroplating methods, two modifications in particular, result in the formation of uniform layers of metals plated on the substrate. First, surprisingly, agitation of the electrolyte must be eliminated or substantially minimized. The electrolyte must be quiescent. No external agitation, for example by stirring, should be employed. “External agitation” as used herein means any agitation of the electrolyte additional to such agitation caused by current flow, for example, agitation caused by an external object in the bath containing the electrolyte or agitation caused by an agent external to the bath. Second, an “effective current density”, or the corresponding potential to yield an effective current density, must be chosen and employed. This “effective current density” is dependent upon and appropriate for the composition of the electrolyte selected. How to determine and apply an effective current density is described more fully in the detailed description below. Optionally, a third modification may be employed to further assist in obtaining a uniform plating thickness: the cathode and anode may be horizontally disposed along their longitudinal axes in closely spaced-apart parallel relation to each other in the electrolyte bath. If the cathode is dispose closest to the surface of the electrolyte solution, the anode is then disposed horizontally and in a parallel longitudinal direction below the cathode. Disposing the electrodes horizontally eliminates convective flows at the electrode surface further minimizing electrolyte mixing. At least the first two of these modifications (use of an effective current density without external agitation), if employed in the electroplating of the absorber layer of a PV cell device, eliminate or ameliorate one of the major problems associated with using electro-deposition to manufacture these devices: thickness non-uniformity of the layers deposited. Although these modifications may find particular use in the manufacture of PV cells and other semiconductor devices, they find generally applicability in any electroplating setting for depositing thin, uniform, layers on a substrate.

Although electro-deposition without external agitation has been conducted in the past, it has not been appreciated that plating without external agitation results in improved thickness distribution. In the case where electro-deposition has been carried out without agitation in electrochemical studies, the electrodes used were typically exceedingly small (less than 1 cm²) and no measure of the thickness distribution was disclosed. In fact, in many electrochemical experiments in which no external agitation has been employed, microelectrodes with the smallest possible surface area are used. These electrochemical studies are basic scientific studies, and as such, not intended to translate into production scale processes. For production scale processes, this inventor is unaware of any prior art that employs electro-deposition without external agitation. In the case of electro-refining or electro-winning of metal, where no external agitation is employed to minimize cost, agitation is provided by the convective flow in the cells and the cells are designed to maximize this effect. Other than the studies disclosed herein, the only other basic scientific study in which electroplating without agitation, in an unstirred bath, was used resulted in layers of non-uniform thickness deposited on the cathodic substrate. See Kurihara, Phys. Status Solidi C6: 1241-44 (2009). In that study, sequential layers of Cu, Sn and Zn were plated from an unstirred bath using a vertically oriented glass cathode measuring 1.2 by 1.2 cms. The authors reported significant variations in composition over the surface of the cathode and concluded that plating from unstirred electrolyte leads to poor thickness and composition uniformity.

### BRIEF DESCRIPTION OF THE DRAWINGS

FIG. 1 is a graphic representation of the plating potential plotted over time showing effective current densities for the electro-deposition process using a tin gluconate plating electrolyte, as described in Example 5.

FIG. 2 is a graphic representation of effective current density plotted as a function of copper ion concentration in an acidic copper-plating electrolyte in the electroplating process described in Example 1.

FIG. 3 is a graphic representation of the normalized thickness of a layer of tin plated on a polyimide film, as a function of position along the substrate versus time. The polyimide film substrate was sputter with Mo and with a 100 nm seed layer of Cu. The 23 cm×14 cm substrates were tin-plated at 3 ASF for 0.5, 1 and 2 minutes in a 15 gm/l tin gluconate electrolyte at pH 2.5, without external agitation.

FIG. 4 is a graphic representation showing the normalized thickness of tin, plated on two 23 cm×14 cm polyimide substrates as a function of position along the substrate versus time. The substrates were plated at 3 ASF for 2 minutes in 15 gm/l tin gluconate electrolyte at pH 2.5, one substrate was plated with external agitation and one substrate was plated without external agitation.

FIG. 5 is a graphic representation showing the mean thickness of tin plated on a 23 cm×14 cm polyimide substrate as a function time. The substrate was plated at 3 ASF in a 15 gm/l tin gluconate electrolyte, without external agitation.

FIGS. 6 and 7 are graphic representations showing the thickness of copper plated on two 23 cm×14 cm polyimide substrates as a function of position along the substrate versus time. The copper was plated at 4.5 ASF for 3.5 minutes in a 7.5 gm/l copper, 11% Acid, bright copper plating electrolyte at pH 2.5, without external agitation (FIG. 6) and with external agitation (FIG. 7), as described in Examples 1 and 2, respectively.

FIG. 8 is a graphic representation showing the thickness of copper plated on a 23 cm×14 cm polyimide substrate as a function of position along the substrate. The copper was plated at 4.5 ASF for 10 minutes in a 30 gm/l copper electrolyte at pH 2.5, without external agitation as described in Example 3.

FIG. 9 is a graphic representation showing the thickness of copper plated on a 23 cm×14 cm substrate as a function of position along the substrate. The copper was plated at 1.0 ASF for 40 minutes in a 6 gm/l copper electrolyte at pH 2.5, with the cathode substrate in physical contact with a napped polypropylene interposer and without external agitation as described in Example 4.

FIG. 10 is a graphic representation showing the thickness of tin plated on a 23 cm×14 cm substrate as a function of position along the substrate. The tin was plated at 3.0 ASF for 2 minutes in a 15 gm/l tin gluconate electrolyte at pH 2.5, without external agitation as described in Example 5.

FIG. 11 is a graphic representation showing the thickness of zinc plated on a 23 cm×14 cm substrate as a function of position along the substrate. The zinc was plated at 3 ASF for 1.0 minute in a 10 gm/l zinc electrolyte at pH 2.5, without external agitation as described in Example 6.

FIG. 12 is a graphic representation showing the thickness of indium plated on a two 23 cm×14 cm substrates as a function of position along the substrate. The indium was plated with agitation at 6 ASF for 3 minutes in a 15 gm/l indium chloride electrolyte at pH 2.5, and the sample without external agitation was plated at a constant potential of 0.6 V for 3 minutes as described in Example 7.

FIG. 13 is a graphic representation showing the thickness of indium plated on a 23 cm×14 cm substrate as a function of position along the substrate. The indium was plated at a constant potential of 0.6 V for 2 minutes in a 15 gm/l indium chloride electrolyte, without external agitation as described in Example 8.

FIG. 14 shows a side view of one implementation of the current invention, with the cathode and anode situated horizontally, in close proximity and parallel to one another.

FIG. 15 shows a side view of an implementation of the current invention, with the cathode in contact with a porous, electrically non-conductive interposing element.

FIG. 16 shows a side view of an in-line apparatus for carrying out the present invention.

### DETAILED DESCRIPTION OF PREFERRED EMBODIMENTS

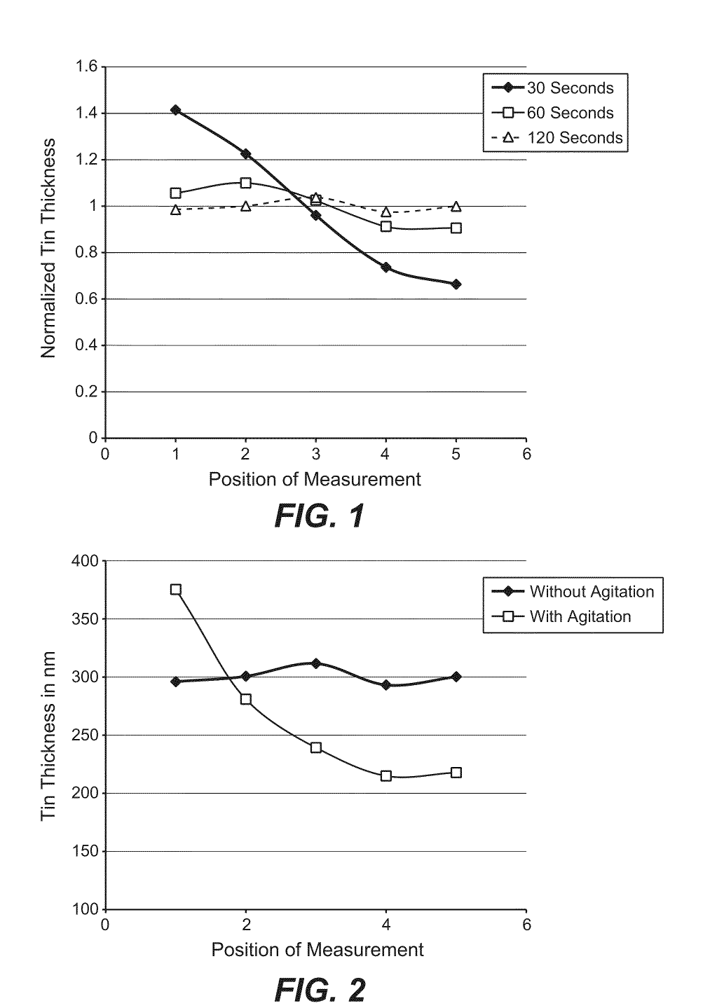

The invention is an apparatus and method for forming uniform layers of metal on a substrate by electro-deposition. (A uniform layer as defined herein will have a thickness coefficient of variation of less than 10%, preferably less than 7%.) The method comprises electroplating the substrate in a bath composed of a quiescent (i.e., no external agitation) electrolyte solution. It must also be appreciated that in order for this invention to function properly, an “effective current density”, or the corresponding potential to yield an “effective current density”, also must be carefully selected to match the chemical composition of the electrolyte. Selecting too low a current density will result in insufficient concentration over-potential at the cathode surface, and a deposit with uniform thickness will not be obtained. Selecting too high a current density will result in a rough deposit and/or hydrogen evolution and “burning” at the cathode surface. The proper “effective current density” (not too high nor too low) can be readily determined using routine experimentation as follows. The plating cell voltage can be employed as an indication that a proper effective current density for the chemical composition of the electrolyte has been chosen. During the plating process of the invention, the cell voltage increases appreciably and in a stepped manner, due to an increase in the concentration over-potential, as would be expected according to the current theory of the mechanism of the invention set forth below. At an insufficient current density, this stepped rise in cell voltage is not observed. At a current density that is too high, this stepped cell voltage rise will occur almost immediately upon initiation of the plating process, such that there is too short a plating time to yield an adequate thickness of deposited material before gas evolution at the electrode occurs and a rough deposit is formed. At current densities appropriate to the functioning of the invention, i.e., the “effective current density”, an appreciable increase in cell voltage, is observed near the end of the plating interval and it is under these conditions that a uniform layer of metal will be deposited on the cathodic substrate. Therefore, choosing a current density such that a stepped increase in the cell potential is observed during the plating process is an appropriate and easily managed way to determine an appropriate effective current density. Once this stepped increase is observed, the plating process can be stopped. This effective current density is dependent upon the nature and constituents of the plating electrolyte; higher electrolyte metal concentrations require higher current densities. This is illustrated by the data reproduced in FIG. 1 in which current potential is plotted as a function of plating time. As plating is initiated, the cell potential increases gradually as an ion-depleted layer grows on the cathode surface. The ion-depleted layer causes greater electrical resistance to the current flow and results in an increase in the cell voltage. The ion-depleted layer develops first in areas of high current density, typically at the cathode edges, and spreads to lower current density areas as the current flows to areas of lower resistance with thinner ion depleted layers. When the entire cathode surface has developed an ion-depleted layer, a stepped increase in the cell potential is observed. At to low a current density (bottom line plot), mass transport rates are sufficient to replenish the layer at the cathode, and an ion-depleted layer with a high concentration over-potential is not formed and a stepped increase in cell potential is not observed. At a current density too high (top line plot), the stepped increase occurs so quickly there is insufficient time for a layer of the required thickness to form before hydrogen evolution occurs and a rough deposit is formed. Neither of these current densities is “effective” for the chosen electrolytes. An effective current density is represented by the line plots between the uppermost, too high, line plot and the lowermost, too low, line plot. In the example shown in FIG. 1, an effective current density is in the range between 2.4 and 3.6 ASF. In FIG. 2, effective current density is shown as a function of copper ion concentration in an acidic copper-plating electrolyte. Those skilled in the art will readily appreciate that each metal and each specific type of metal electrolyte solution will behave differently and that some routine experimentation will be necessary to determine the best combination of electrolyte composition, current density and plating cycle time for the chosen application. The level of experimentation is minimal however, since a stepped cell voltage rise is reliably observed during the plating process if the parameters have been chosen correctly.

The plating time is dependent upon the proper experimentally determined current density for plating. A typical PV cell has a total thickness in the range of 900 to 1200 nm with individual metal layers to form the thin film precursor in the range of 100 to 400 nm thick. When plating the PV cell precursor layers for example, a plating time is chosen to yield layers in that latter range. If thicker layers are desired, the invention can be conducted repeatedly, by providing agitation, then conducting the process of the invention (i.e., plating without agitation at an effective current density as defined herein), and repeating this sequence as needed such that more than one uniform thin layer is deposited and the numerous uniform thin layers are built-up on the substrate. The plating current may be continuous, pulsed, or periodic pulse reverse. The plating may be carried out at a constant current or at a constant potential, or both current and voltage may change during the plating process. In either event, the current or the potential must be selected such that the resulting current density is appropriate to the function of the present invention over the plating interval.

While not critical to the functioning of the invention, one additional optional modification assists in the function of the present invention; the anode and cathode may be positioned horizontally and parallel to each other in relatively close proximity in the electrolyte bath. Spacing between 0.5 to 30 cm is preferable. A too close spacing may result in current mal-distributions due to small misalignments in position between the cathode and the anode. A too far spacing requires more tank volume and also results in a large ohmic resistance in the plating cell. To prevent irregular and non-uniform distributions of deposited metal using closely space-apart electrodes due to misalignments in positioning, it is preferable to place the electrodes at least 0.5 centimeters apart from each other. To minimize the tank volume and cell voltage, the electrodes should be placed no more than 30 cm apart from each other. A distance somewhat outside that range could also be employed, and can readily be determined using ordinary skill in the art. A larger distance may be used without detracting from the function of the invention, however, it offers no advantage. Preferably, the anode and cathode are positioned in spaced-apart parallel relation to each other and horizontally disposed along their longitudinal axes. The cathode may be disposed above the anode and accordingly, the anode is then disposed horizontally in a parallel longitudinally direction below the cathode, but the positions of the anode and cathode in the bath may be reversed, with the cathode below the anode. An electrical current is passed between the anode and the cathode for a sufficient interval of time at a suitable effective current density to form a uniform layer of metal on the cathodic substrate of the required thickness. The plating may be carried out at a constant current or at a constant potential, or both current and voltage may change during the plating process. In either event, the current or the potential must be selected such that the resulting current density is appropriate to the function of the present invention over the plating interval.

Also provided is an apparatus for electroplating one or more metals on a substrate. The apparatus consists of a series of tanks, containing cleaners, electroplating solutions and rinses, and means for conveying the substrate from tank to tank as is required to form the desired metal stack. During plating, the substrate is stationary in the electroplating tank with the electrolyte in proximity to the cathode maintained still. As described above, optionally the cathode and anode are disposed and positioned horizontally in the electrolyte bath in closely spaced-apart parallel relation to each other.

Multiple metals may be deposited from the electrolyte under quiescent conditions, so that an alloy is formed in a single-step process. By adjusting the concentrations of the individual metal ions in the electrolyte, the composition of the deposited metals can be controlled. As is appreciated by those skilled in the art, the electrolyte composition must be properly formulated to successfully deposit the alloy. Because the metals in the electrolyte will be present in different concentrations and will have different reduction potentials, it is expected that the alloy composition may vary as a function of time during the use of the current invention. It also is expected that the initial plating will be rich in the most readily reduced metal, however, as the plating proceeds and the most readily reduced ions are depleted in the electrolyte adjacent to the cathode, the other metals present will be reduced in turn. This does not present a problem for forming PV cell precursor layers, since they will readily inter-diffuse during the high temperature annealing process used to sulfurize or selenize the precursor (absorber) layer and form the semiconductor alloy layer. In fact, the present invention is advantageous in depositing alloy layer versus conventional plating, and allows a wider range of alloy compositions to be deposited than is possible using conventional plating where liquid agitation at the cathode is used. The present invention may be used to electro-deposit any metal reducible from an electrolyte. Exemplary are the Group IB, IIIA or VIA transition metals. In particular, metals employed in PV cell manufacture such as copper, tin, zinc, indium, gallium, selenium, cadmium, and tellurium may be deposited using the methods and apparatus of the invention. Although the primary application of the present invention is in forming thin film PV cell precursor layers, the invention finds utility in other applications as well, including for example, copper via fill applications on semiconductor wafer manufacture, semiconductor bump plating, via fill of circuit boards, and plating of front side grid lines of PV cells. Further, other metals useful in these and in other applications can be deposited, such as for example gold, silver, thallium, tungsten, germanium, and bismuth, and oxides of indium, zinc, tin, antimony, titanium or combinations thereof, may be deposited using the process of the invention. Particular combinations of metals that may be plated include copper, tin zinc, selenium; copper, indium selenium; copper, gallium and selenium; copper, gallium, indium and selenium; and cadmium and tellurium. Selenium may be plated as an alloy, for example as a gallium selenium alloy or an indium selenium alloy, or in alloy with any of the other metals forming the precursor metal stack. Any metals to be electrodeposited, either individually or in various combinations, and in thin-films or thick-films, may be deposited employing the process of the invention. The invention further includes articles of manufacture having one or more metal layers made by the process of the invention. Such articles may include, without limitation, PV cells and semiconductor wafers.

Not intending to be bound by theory, the following is a qualitative explanation of the believed function and operation of the invention. The transport of metal ions to the cathode surface during electro-deposition in practical electrolytes is primarily diffusion driven and can be described using Fick's equation. During electro-deposition, an ion-depleted layer grows with time as metal ions are reduced at the cathode surface. Metal ions are transported to the cathode by diffusion induced by the ion concentration gradient normal to the cathode surface. When the electrolyte is agitated, a hydrodynamic boundary layer forms and the ion-depleted layer reaches a steady state thickness referred to as the Nernst layer thickness. If the liquid agitation is uniform over the surface, the Nernst layer thickness is also uniform.

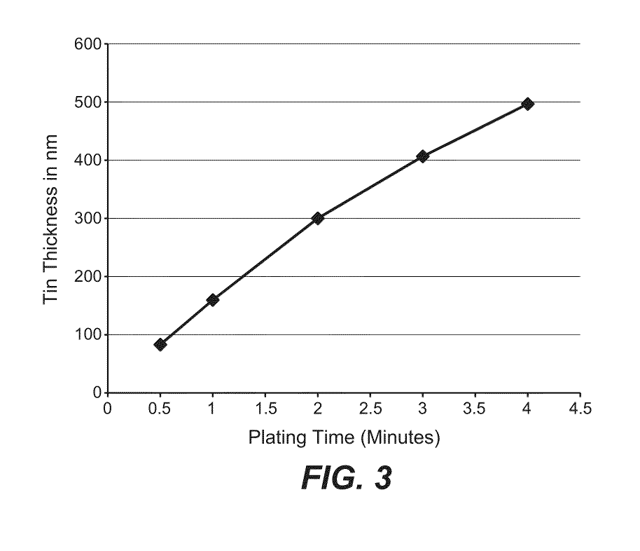

In a non-agitated electrolyte, the ion-depleted layer increases in thickness as current is passed from the electrolyte to the cathode surface and does not reach a limiting steady state thickness. The concentration over-potential between the cathode surface and the bulk electrolyte is a function of the ion depleted layer thickness and is greater for thicker ion-depleted layers. Therefore, current flows to areas with thinner ion-depleted layers due to the lower electrical resistance of the thinner layer. This phenomenon results in the growth of an ion-depleted layer of uniform thickness as well as a uniform electro-deposited metal layer. The edges of the cathode, which are high current density areas, initially have higher deposit thicknesses, however, as the ion-depleted layer at the edges grows, the current will flow to areas with a thinner ion depleted layer and a lower electrical resistance. FIG. 3 shows the thickness profile for a 23 cm×14 cm substrate electroplated in a 15 gm/l tin gluconate electrolyte at 1 A, for 30, 60 and 120 seconds, with no agitation. The normalized thickness is the measured thickness divided by the mean thickness. Position one is approximately 1 cm from edge of the substrate near the cathode connection and position 5 is the substrate center. As can be seen from the chart, the thickness at 30 seconds is much greater at the edge of the cathode than it is in the center. However, this difference is greatly reduced at 60 and 120 seconds. This is in agreement with the theory presented above.

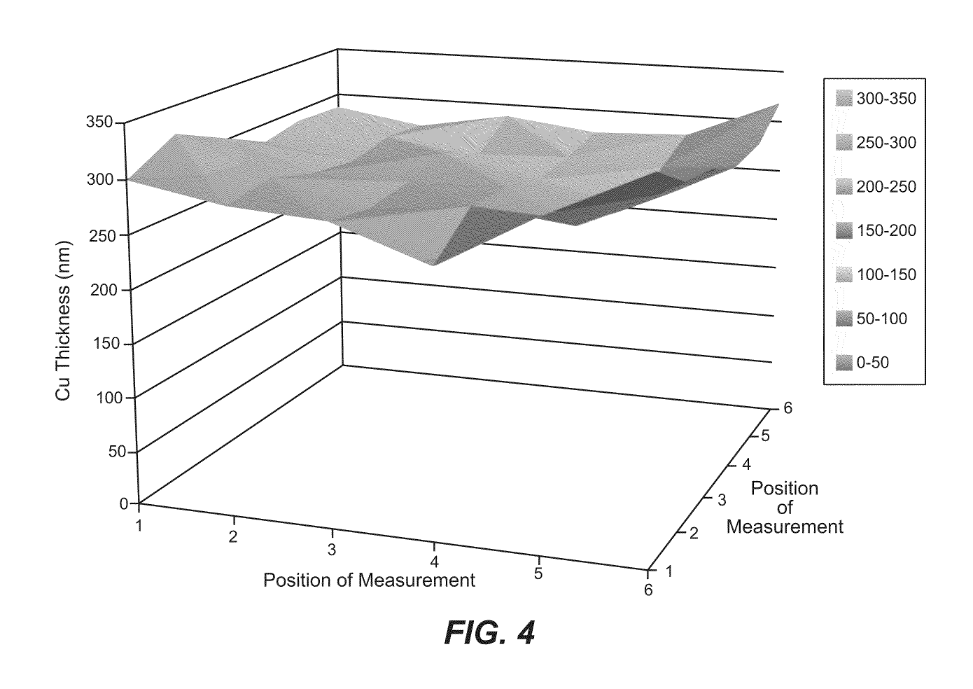

A direct comparison between plating with agitation and plating without agitation is given in FIG. 4. The plating conditions were a 23×14 cm cathode, plating current 1 A, 2 minutes, from a 15 gm/l tin gluconate electrolyte. As can be seen from the figure the sample plated without agitation is uniform in thickness while the sample prepared with agitation has a large variation in thickness with the greatest thickness concentrated near the cathodic contact at the outer edge of the substrate.

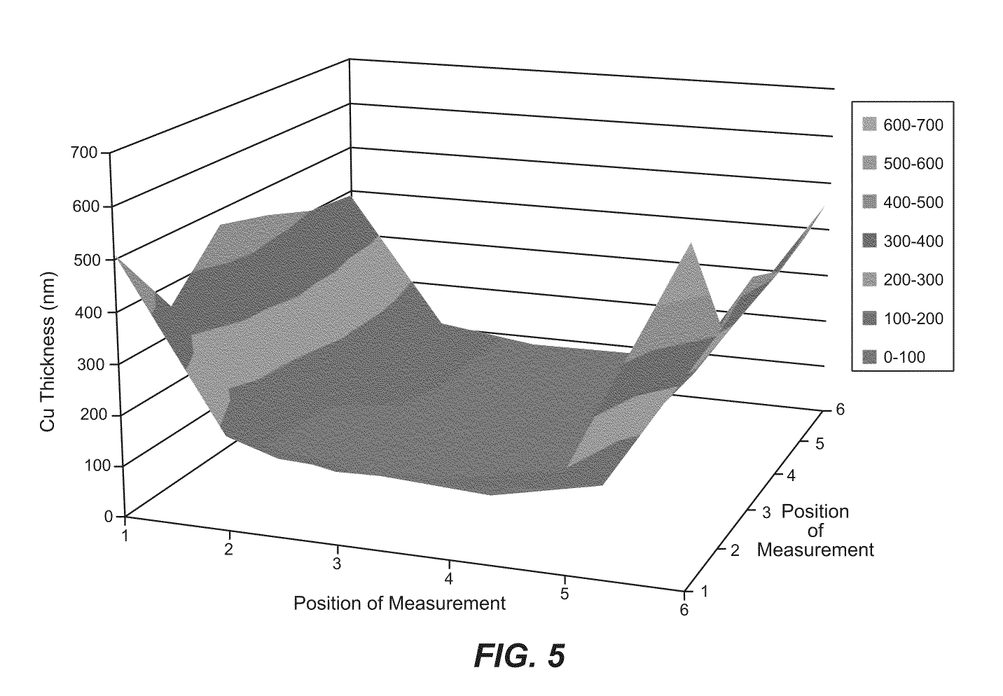

In the practice of the present invention the current density for a given electrolyte must be selected to be sufficiently high to form an ion depleted layer, which grows in thickness with time during electro-deposition. However, the current density cannot be so high that the metal ion concentration at the cathode surface goes to zero resulting in hydrogen evolution at the cathode and a rough or powdery deposit. FIG. 5 shows the thickness of tin deposited at 3 ASF as a function of time. As can be seen from the figure, the tin thickness is linear with time for about two minutes and then the tin layer growth rate begins to gradually decline. This behavior indicates that the concentration of tin at the cathode surface is decreasing slowly during the plating process but is sufficient to prevent hydrogen evolution for at least a period of 5 minutes. Moreover, FIG. 3 shows that the plated layer becomes uniform within 2 minutes. This indicates that a fairly large operating window exists to form uniform metal layer of good morphology and without gas evolution using the present invention. However, it is important to select the proper current density for a given electrolyte. Appropriate current densities can be found by routine experimentation. Electrolytes with low metal concentrations will require lower current densities, while electrolytes with higher metal concentrations will require higher current densities. Furthermore, using higher current densities with higher metal concentration will result in faster deposition rates than using lower electrolyte metal concentrations and lower current densities. However, faster deposition rates may make it more difficult to obtain the precise thickness that is desired. An additional consideration in selecting the current density is the limited conductivity of the substrate conductive seed layer, which will also favor using a lower current density.

The invention has been demonstrated to work at current densities between 0.35 and 10.7 ASF. Current densities outside of this range may also be used if appropriate electrolyte conditions are selected: lower concentrations of metal for lower current densities and higher concentrations of metal for higher current densities. The proper current density can be quickly determined using routine experimentation. The plating cell voltage can be used as one indication of whether a sufficiently high current density has been chosen. The cell voltage typically shows a stepped increase during the plating process of the current invention. See FIG. 1. This is expected according to the mechanism of the present invention. When conducting plating without external agitation but using an insufficient current density, the appreciable stepped increase in the cell voltage is not observed and a uniform deposited layer is not formed. At current densities appropriate to the function of the current invention, this stepped, appreciable increase in voltage is observed during the later stages of the plating interval and it is under these conditions that a uniform deposited layer is formed. Therefore, employing a constant current density such that a stepped increase in the cell potential is observed during the plating process is one way of determining an effective current density for the present invention. An effective current density will depend on the nature of the plating electrolyte; higher electrolyte metal concentration will require higher current densities. FIG. 1 shows effective current densities for the function of the present invention (i.e., effective to obtain layer thickness uniformity) as a function of copper ion concentration in an acid copper-plating electrolyte. Those skilled in the art will appreciate that each metal and each specific type of metal electrolyte behaves differently and that experimentation will be required to determine the best combination of electrolyte composition, current density and plating cycle time for a given application. The invention has been demonstrated by electroplating layers of uniform thicknesses of copper, tin, indium and zinc as individual layers without external agitation and using a current density in the range of effective current densities for the composition of the electrolyte solution. For certain metals having high reduction potentials, for instance indium and gallium, the invention has been demonstrated using an effective constant voltage while allowing the current density to vary. The appropriate cell voltage is selected such that corresponding current density is appropriate for the function of the present invention at the beginning of the plating interval. It is expected that the current density will decrease over the plating interval as the cell resistance increases due to the increasing concentration over potential at the cathode. This is demonstrated in Examples 7 and 8 by electroplating uniform thicknesses of indium. Whether employing constant voltage or constant current, because high reduction potential metals such as gallium and indium are prone to hydrogen evolution at the cathode during plating, vertically disposed electrodes, or alternatively horizontally disposed electrodes with the anode above the cathode should be used to prevent hydrogen from being trapped on the cathode surface. Alternatively or in addition, gallium alloys or indium alloys, having lower reduction potentials than pure gallium or indium may be plated as a means of preventing gas evolution. Another possibility is to increase the pressure of the electrolyte to suppress gas bubble evolution. The invention is further described by way of the following examples.

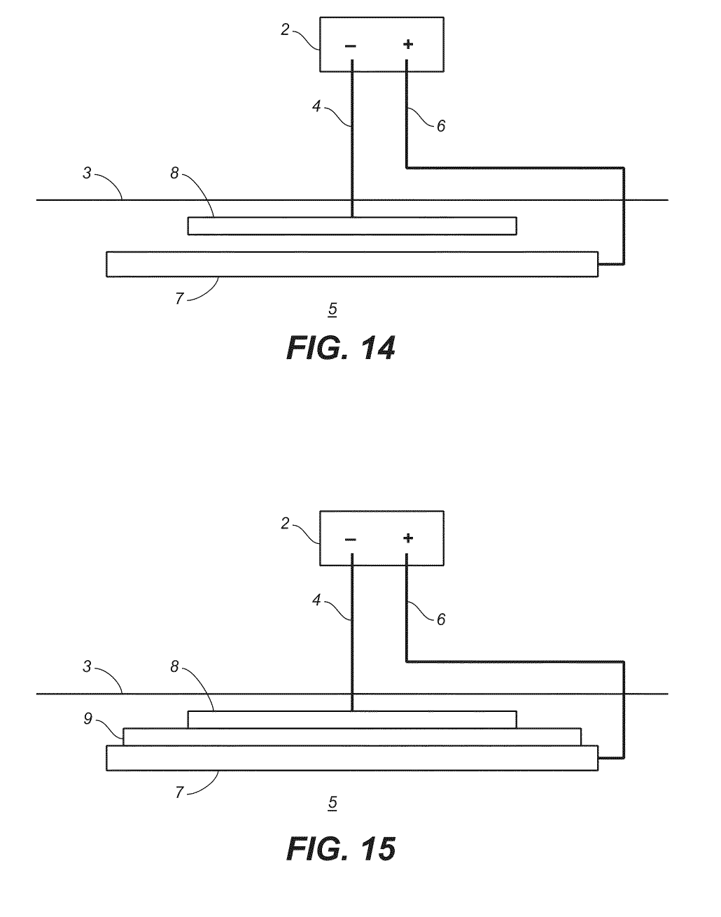

One embodiment of the invention in which the cathode and anode are positioned in parallel, horizontally disposed, spaced-apart relation to each other in the electrolyte bath is illustrated in FIGS. 14 and 15. Referring to those figures now, there is shown in both power source 2 connected to cathodic substrate 8 by means of electrical connector 4 and to anode 7 by means of electrical connector 6. Cathodic substrate 8 and anode 7 are disposed in electroplating bath 3, which contains electrolyte solution 5. Both substrate 8 and anode 7 are disposed horizontally and in parallel spaced-apart relation to each other within bath 3 below the surface level of electrolyte solution 5. In FIG. 15, interposer sheet 9 is positioned between cathode 8 and anode 7. Interposer sheet 9 may be composed of napped, polypropylene cloth having the same length and width dimensions as the cathode and a thickness of approximately 2 mm. Positioning such an interposer sheet and selecting suitable materials from which to make it is well within the level of skill in the art.

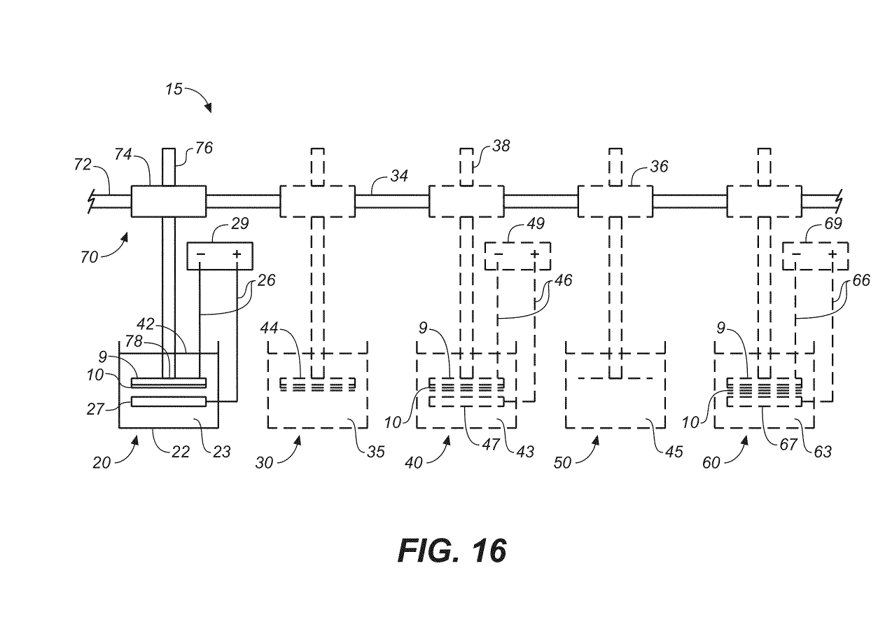

A schematic diagram of an apparatus that may be used for carrying out the electro-deposition steps of the invention in an in-line manner is shown in FIG. 16. The apparatus will be described using as an example electro-deposition of copper, indium, and gallium, although it will be obvious to those skilled in the art that the apparatus design may be employed to practice any other. In the apparatus as shown, the anode and cathode are disposed horizontally as described in the optional embodiment of the invention. Alternatively, the anode and cathode may be disposed in the electroplating cell or bath in the usual vertical manner. The apparatus, 15, is an in-line system having multiple stations that processes a substrate 9 in the form of a flexible foil or rigid sheet. Depositions are carried out on a layer of conductor material (typically molybdenum with a copper seed layer), 10, which has already been coated onto the surface of the substrate that faces the anode. First a thin, uniform copper layer, 21, is deposited on conductor layer 10 in the Cu electroplating station 20. Cu electroplating station 20 is composed of an electroplating cell having an enclosure, 22, made of an insulating material. Enclosure 22 receives the electroplating solution, 23, appropriately chosen for the deposition of copper. An anode, 27, composed of copper, is disposed in enclosure 22 in spaced-apart relation to the substrate as already described and in a manner already known in the art. Alternatively, an insoluble anode may be used, such as a platinum coated niobium or iridium oxide coated titanium electrode. If an insoluble anode is used, a membrane (not shown) is positioned between the anode and the cathode to prevent oxygen generated at the insoluble anode from accumulating at the downwardly facing cathode. Preferably this membrane is sloped to deflect gas bubbles horizontally away from the electrodes and is composed of a non-metallic material which will not interfere with the passage of current. Cloth, plastic mesh, or ionic membranes as well as other suitable material may be used for this purpose. Electrical contacts, 26, connected in the usual manner to a power source, 29, and at least touching a surface of substrate 9 and a surface of anode 27 complete the circuit. When electroplating solution 23 is still, and there is no detectable movement of the solution in the enclosure, voltage is applied between substrate 9 and anode 27 at an effective current density and Cu ions move out of electroplating solution 23 and onto conductor layer 10 of substrate 9 to form a thin, uniform layer of copper on the surface of the substrate facing the anode. How to determine an effective current density is explained above. Once the surface of conductor 10 is adequately coated with the Cu deposit, transport means 70 transports substrate 9 to a rinse station, 30, where the substrate having the deposited Cu layer is submerged in an appropriate rinse solution 35 and is rinsed and cleaned of any chemical residue. Next, the substrate moves to indium electroplating station 40, similar in composition and structure to the Cu electroplating station but which contains an electroplating solution, 43, appropriately chosen for the deposition of Indium. An electrical contact, 46, attached to the anode, 47, is contacted with the surface of substrate 9 through power source 49 and voltage again applied at an effective current density for this electrolyte composition and for a sufficient time to create a deposited layer of In. Once the surface of conductor 10 is adequately coated with In layer 31, substrate 9 moves to a second rinse/dry station, 50, where the substrate having the deposited Cu and In layers is submerged in an appropriate rinse solution, 45, and is rinsed and/or dried. Substrate 9 with conductive coating 10 next moves to gallium electroplating station 60, similar in composition and structure to the Cu electroplating station but which contains an electroplating solution 63 appropriately chosen for the deposition of gallium. An electrical contact, 66, attached to the anode, 67, is contacted with the surface of substrate 9 through power source 69 and voltage again applied at an effective current density for this electrolyte composition. Once the surface of conductor 10 is adequately coated with the gallium layer, 41, substrate 9 moves to a third rinse/dry station (not shown) where the surface of deposited Cu, In, and Ga layers, 21, 31 and 41 respectively are rinsed and/or dried.

Transport means 70 is composed of stationary beam 72, movement means 74 containing a power source, means for mounting movement means 74 on stationary rail member 72 and substrate pick-up and release means 76. Movement means 74 includes a power source, means for retractably mounting movement means 74 onto the stationary beam so as to allow reciprocating movement along the beam from station to station and means for attaching substrate pick-up and release means 76 to movement means 74. Substrate pick-up and release means 76 is composed of a rigid columnar or tubular non-conducting material removably attached at or near one end to movement means 74 and decending from it vertically. The other end of substrate pick-up and release means 76 includes substrate holding means 78, which releasably attaches to the back surface of substrate 9 (i.e., the surface of substrate 9 not facing the anode) such that substrate 9 is demountably attached to holding means 78. Substrate holding means may take the form of, for example, clamps, clips, pins, latches, hold down or other releasable couplings. Element 76 moves vertically with respect to movement means 74 allowing the element 78 to be raised above the walls of tank 22 so that the assembly of 74, 76, 78, 9 and 10 can be moved horizontally along rail member 72, such that any tank can be accessed by the assembly. The substrate may be advanced through the various stations by dipping as is illustrated, or by a roll-to-roll or continuous process in a horizontal configuration where the substrate is advanced in intervals and is stationary during the plating process.

The preferred mode of operation is “in line” as shown in FIG. 16, but it should be understood that the various stages of the electroplating method of the invention may also be carried out in separate pieces of equipment. And although three electroplating process stations are illustrated in FIG. 16, more stations may be employed. Further, selenization or sulfidation stations may be added at the end of the in line process for reacting the newly deposited layer stacks with Group VIA metals. Such selenization or sulfidation techniques are well known in the art and need not be described here. See for example, U.S. patent Publication No. 2006-012170 which briefly describes these techniques. Solar cells may be fabricated from the finished substrate using materials and methods known in the art. Id. Further, flexible thin film substrates may be employed, see United States Patent Publication No. 2008/0128013 published 5 Jun. 2008 (Applied Materials). A protective coating layer may then be applied as described in United States Patent Publication No. 2010/0218814 published 2 Sep. 2010.

All of the embodiments of the invention may be carried out using solutions with various additional additives, such as brighteners, carriers, complexers and surfactants, which are typically used in electroplating. These will influence the function of the present invention and routine experimentation may be used to determine the optimum concentration of these additives. In addition, pre-cleaning of the cathodic substrate, as described in PCT Patent Publication No. WO2007/134843 published 29 Nov. 2007, is preferred.

### EXAMPLE 1

### Copper, Without External Agitation

A cathode substrate composed of polyimide film sputtered with Mo and a 100 nm Cu seed layer having the dimensions of 23 cm by 14 cm was immersed in an 11% solution of sulfuric acid, containing 7.5 grams per liter (gm/l) copper as copper sulfate and 5 ml/l D-2 brightener (Technic Inc.), 6 ml/l D-120 Carrier (Technic Inc.) and 70 ppm chloride ions, for 3.5 minutes at 1.5 A (4.3 ASF), at a plating temperature of 20°. The cathode was positioned horizontally and parallel to a copper foil anode with a spacing of 0.4 cm between the anode and the cathode. The plating process was carried out without any external agitation during the plating process.

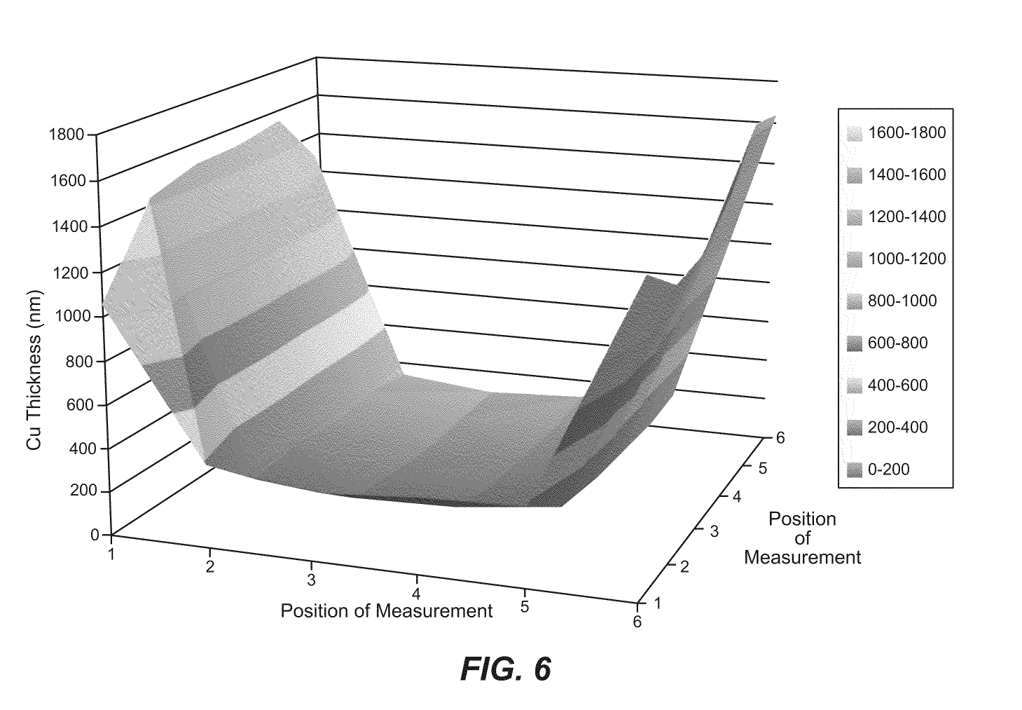

The results are graphically illustrated in FIG. 6, with the vertical axis indicating the thickness of the copper plated onto the cathodic substrate in nanometers and the horizontal axis indicating positions along the substrate's plated surface. The mean thickness of the substrate after electroplating was 284 nm, the standard deviation was 20.5, the coefficient of variation was 7.2%. Given those measurements, and as compared to the results set forth in Example 2 to infra, the Cu layer was uniformly deposited on the substrate.

### EXAMPLE 2

### Copper, With External Agitation

The process according to Example 1 was carried out, except that the plating process was carried out with liquid agitation of the plating solution via reciprocating horizontal movement of the cathode substrate.

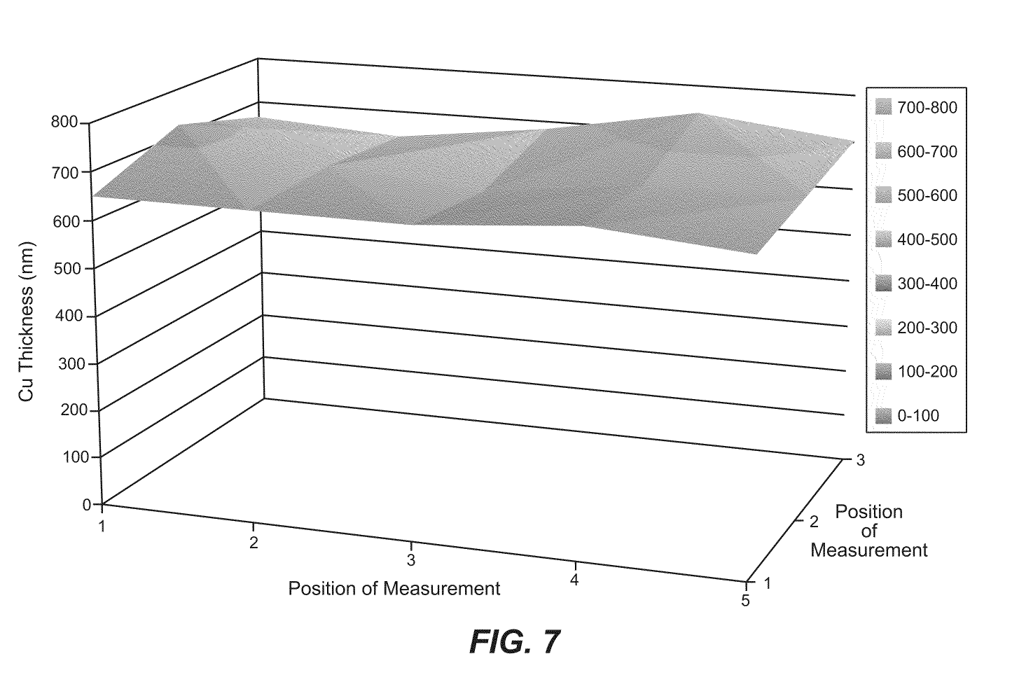

The results are graphically illustrated in FIG. 7, with the vertical axis indicating the thickness of the copper plated onto the cathodic substrate in nanometers and the horizontal axis indicating positions along the substrate's plated surface. The mean thickness of the copper plated on the substrate after electroplating was 220 nm, with a standard deviation of 170, coefficient of variation 77.3%. The effect of external agitation on the thickness uniformity of the deposition as compared to Example 1 can readily be seen. Deposits of up to about 500 nm thick formed at the edges of the substrate whereas deposits of only about 100-200 nm thick formed elsewhere.

### EXAMPLE 3

### Copper, Without External Agitation, Insufficient Current Density

The process according to Example 1 was carried out except that the copper concentration was increased to 30 gm/l (instead of 7.5) and the plating process was run for 10 minutes (instead of 3.5). No increase in cell potential was observed during the plating interval.

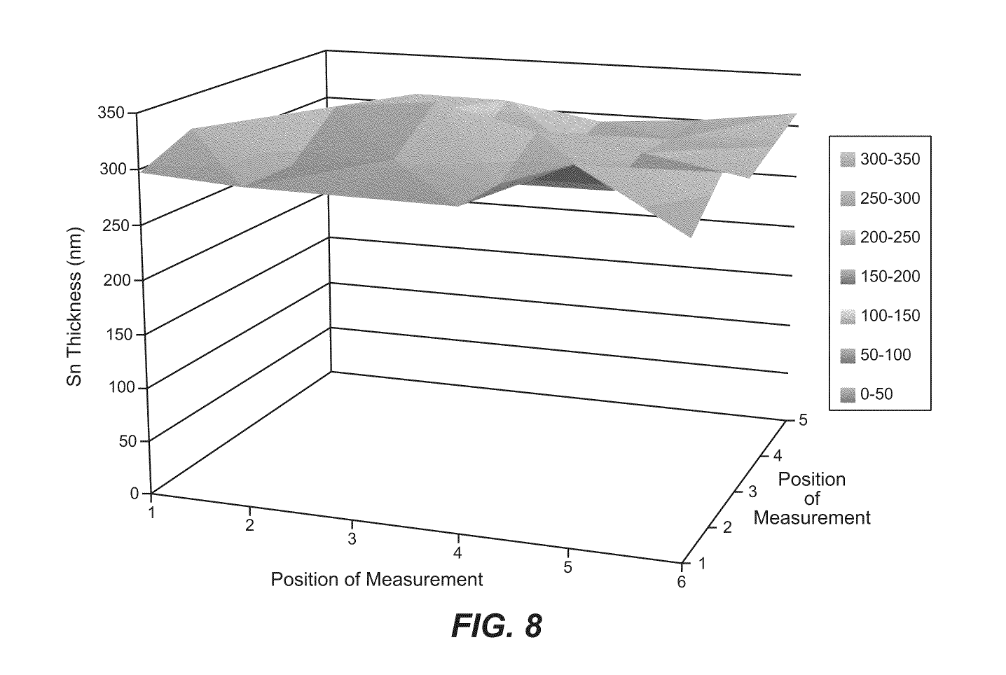

The results are graphically illustrated in FIG. 8, with the vertical axis indicating the thickness in nanometers of the copper plated onto the cathodic substrate and the horizontal axis indicating positions along the substrate's plated surface. The mean thickness of the copper plated on the substrate after electroplating was 584 nm, the standard deviation was 607, and the coefficient of variation was 104%. At the increased copper concentration, the current density was insufficient to form an ion-depleted layer with a concentration over-potential that increases during the plating process. Consequently, the Cu deposits at the edges of the substrate are thicker (up to about 1200 nm thicker) than in the middle of the substrate, despite the lack of any external agitation. This example demonstrates that a lack of external agitation alone will not result in the formation of uniform layers of deposited metals on the substrate. The process must be run at an effective current density in order to form a uniform layer.

### EXAMPLE 4

### Copper, Without External Agitation, Cathode in Contact With Interposer Sheet

The process according to Example 1 was carried out except that a 2 mm thick, napped, polypropylene sheet having the same length and width dimensions as the cathode was interposed between the cathode and the anode and disposed in contact with the cathode, the electrolyte of Example 1 was used except the copper concentration was 6 gm/l. The plating process was run for 40 minutes at 0.35 A (1 ASF).

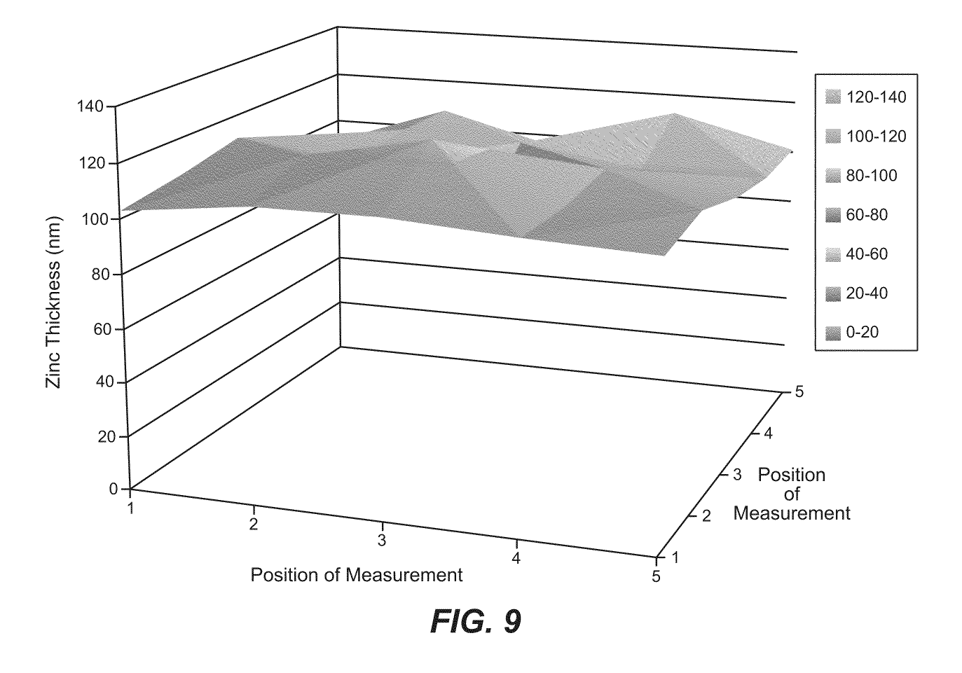

The results are graphically illustrated in FIG. 9, with the vertical axis indicating the thickness of the copper plated onto the cathodic substrate in nanometers and the horizontal axis indicating positions along the substrate's plated surface. The mean thickness of the copper plated on the substrate after electroplating was 668 nm, standard deviation 32, coefficient of variation 4.8%. These results are comparable to results obtained in Example 1 in which the mean thickness of the substrate after electroplating was 284 nm, the standard deviation was 20.5, and coefficient of variation was 7.2%.

### EXAMPLE 5

### Tin, Without External Agitation

The process according to Example 1 was carried using a tin process containing 15 gm/l of tin as tin MSA, 100 gm/l of sodium gluconate as a complexer, 100 ml/l CeramiStan DM Brightener, with a pH of 2.5. The electrolyte temperature was 20 C. The plating process was run for 2 minutes at 1.0 A (2.9 ASF) without any external agitation.

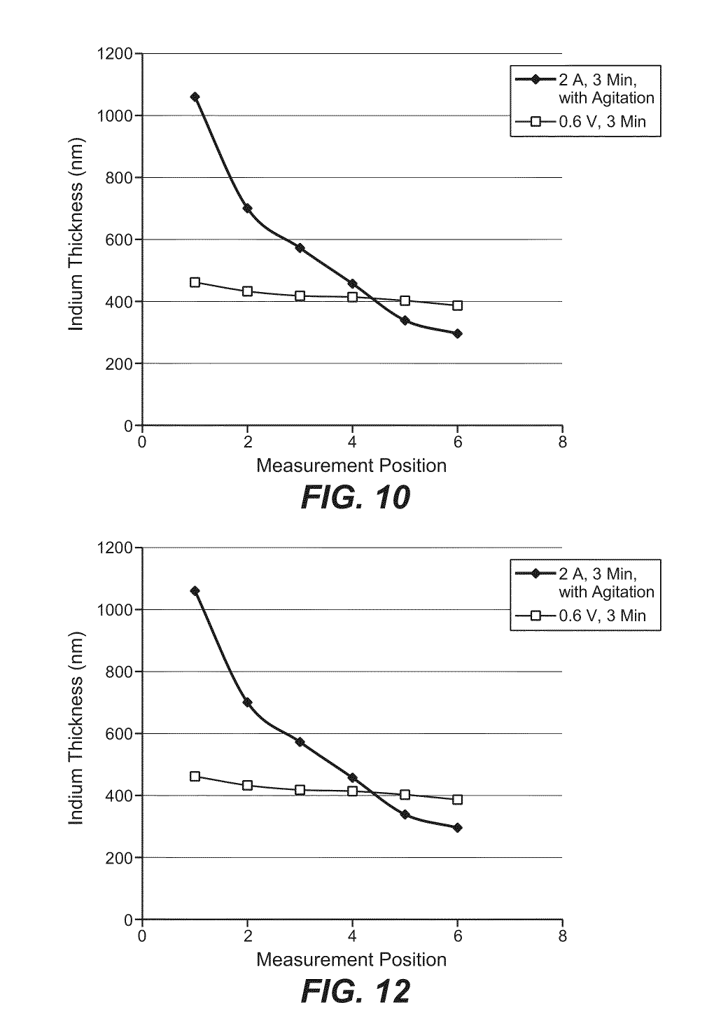

The results are graphically illustrated in FIG. 10, with the vertical axis indicating the thickness of the tin plated onto the cathodic substrate in nanometers and the horizontal axis indicating positions along the substrate's surface. The mean thickness of the tin was 300 nm; the standard deviation was 15.5, the coefficient of variation 5.1%.

### EXAMPLE 6

### Zinc, Without External Agitation

The process according to Example 1 was carried out using a zinc electroplating process containing 10 gm/l zinc as zinc chloride, 163 gm/l of ammonium chloride, and 40 ml/l of Z-53 W brightener (Luster-On Products). The pH was pH 5.6 and the temperature was 20 C. The plating process was run for 1 minute at 1.0 A with a current density of 3.0 ASF without any external agitation.

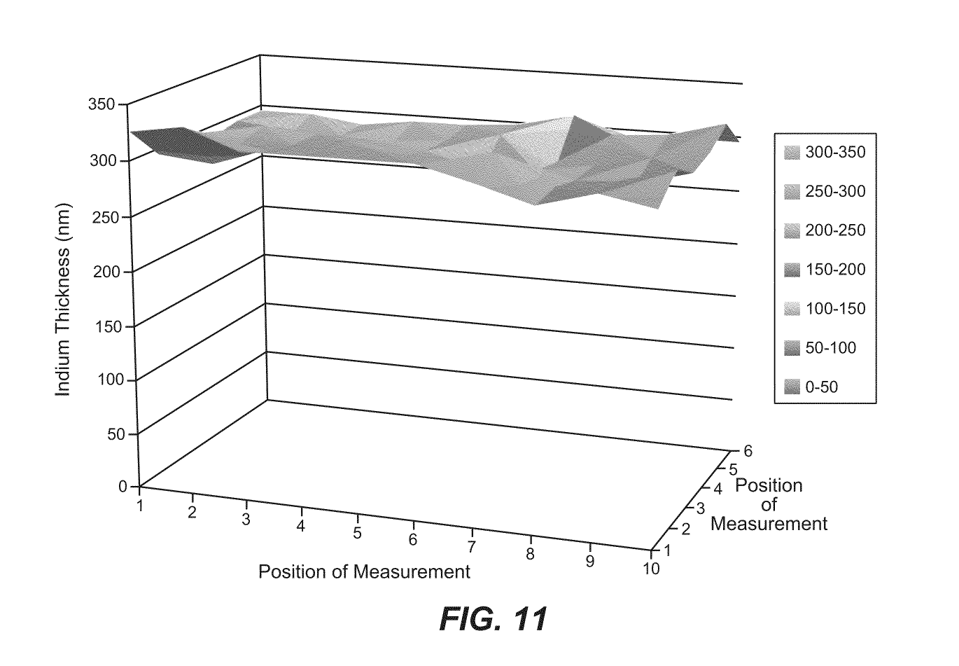

The results are graphically illustrated in FIG. 11, with the vertical axis indicating the thickness of the zinc plated onto the cathodic substrate in nanometers and the horizontal axis indicating positions along the substrate's plated surface. The mean thickness of the zinc plated on the substrate was 104 nm, the standard deviation was 8.6, and the coefficient of variation was 8.2%. Given those measurements, and as compared to the results set forth in Examples 1, 2 and 5, the Zn layer was uniformly deposited on the substrate.

### EXAMPLE 7

### Indium, With and Without External Agitation, Constant Potential

The process according to Example 2 was carried out using an indium electroplating process containing 15 gm/l of indium as indium chloride at pH 1.5. The plating process was run for 3 minutes at 2.0 A (3.0 ASF) with external agitation of the electrolyte solution. Next a process was carried out without electrolyte solution agitation as described in Example 1, and at a constant potential of 0.6 V for 3 minutes with the current allowed to vary. Constant potential was using to prevent gassing at the cathode near the end of the plating interval.

The results are graphically illustrated in FIG. 12, with the vertical axes indicating the thickness of the indium plated onto the cathodic substrate in nanometers and the horizontal axis indicating positions along the substrate's plated surface longitudinally. Position one is approximately 1 cm from edge of the substrate near the cathode connection and position 5 is the substrate center. The mean thickness of the indium plated on the substrate after electroplating without external electrolyte agitation was 419 nm, standard deviation 26, and coefficient of variation 6.2%. The mean thickness of the indium plated on the substrate after electroplating with external agitation was 570 nm, standard deviation 282, and coefficient of variation 49.5%. This direct comparison further confirms the results shown in the previous examples. A uniform layer of deposited metal is obtained when the plating is carried out without any external agitation of the electrolyte solution coupled with selection of plating parameters in the proper range.

### EXAMPLE 8

### Indium, Without Agitation

The process according to Example 7 was carried out except that the cathode dimensions were 11 cm by 23 cm, the plating process was run at a constant potential of 0.6 V for 2 minutes with the current allowed to vary. The current was nominally 3.0 A with a current density of 11.0 ASF for 1.5 minutes, then dropping to 1.3 A (5 ASF) for the last 0.5 minutes.

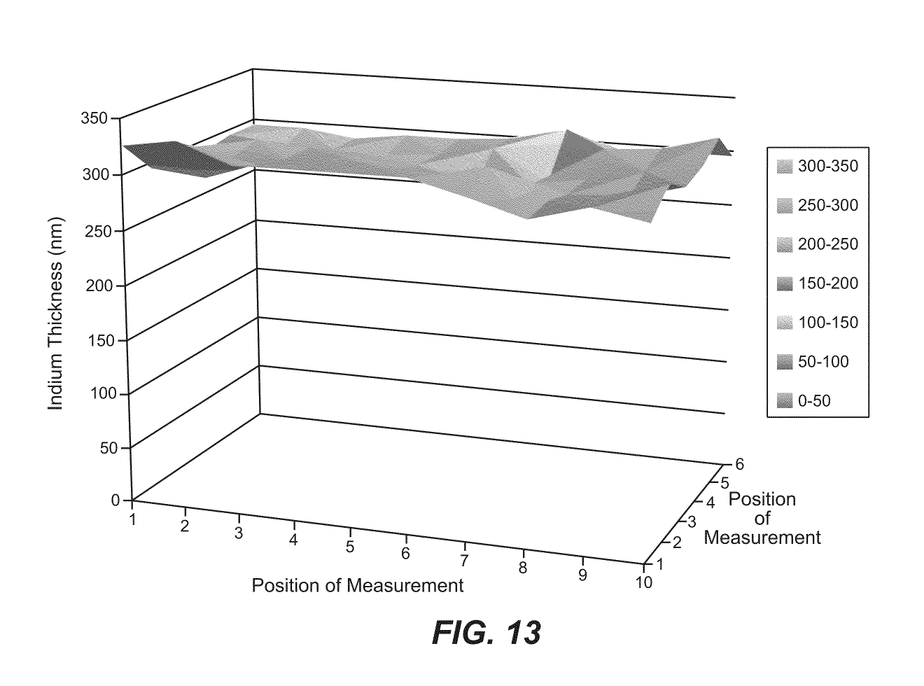

The results are graphically illustrated in FIG. 13, with the vertical axis indicating the thickness of the indium plated onto the cathodic substrate in nanometers and the horizontal axis indicating positions along the substrate. The mean thickness of the indium plated on the substrate was 300 nm, with a standard deviation of 12.2, and a coefficient of variation of 4.1%. Given those measurements, and as compared to the results set forth in Examples 1, 2, 5 and 6, the In layer was uniformly deposited on the substrate.

In Example 12 and 13, constant potential was used to prevent hydrogen gas evolution at the cathode at the later stages of the plating process. The reduction potential of indium is high (−0.34 V) and indium electrolytes (and gallium electrolytes as well) are prone to hydrogen evolution at the cathode. Although, the invention is generally operated with the current held constant and the voltage permitted to vary, the invention can also be operated in a constant potential mode where the voltage is held constant and the current density is permitted to vary. In such situations the current decreases during the plating interval, indicative of the proper voltage having been chosen which results in an effective current density during the initial portion of the plating interval, as described in greater detail above. Local potential differences over the cathode surface will even out the thickness of the deposit, even if the cell potential is held constant. Operating in a constant potential mode is advantageous when depositing metals with high reduction potentials such as gallium and indium, since the cell potential can be selected to prevent hydrogen evolution at the cathode towards during the later portions of the plating cycle. If gassing can not be eliminated, vertical positioning of the electrodes in the bath should be employed to eliminate the possibility of gas being trapped under the cathode. Alternatively or additionally, an Indium alloy or gallium alloy may be deposited instead of pure indium or gallium to further minimize gassing.

### EXAMPLE 9

### Simultaneous, No External Agitation, Ternary Plating of Copper, Tin, Zinc

A cathode substrate composed of glass sputtered with Mo and a 100 nm Cu seed layer having the dimensions of 23 cm by 14 cm is immersed in an electrolyte solution containing 2 gm/l copper as copper sulfate, 3 gm/l zinc as zinc chloride and 2 gm/l tin as tin MSA for 3.5 minutes at 1.5 A (4.3 ASF), at a plating temperature of 27° C., pH 1.5. Supporting electrolytes, such as salts or sodium and lithium, or Na₂SO₄ and an organic solvent such as DMSO as described in PCT Patent Publication No. WO98/48079 published 29 Oct. 1998 or a buffer(s) as described in U.S. Pat. No. 7,297,868 issued 20 Nov. 2007 or other additive(s) as described in PCT Patent Publication WO2007/134843 published 29 Nov. 2007 may be added. The cathode is positioned vertically and an insoluble platinized niobium anode is used, with a spacing of 0.4 cm between the anode and the cathode. The bath is not agitated during the plating process.

A graph of cell potential over time is created to determine if a stepped increase in the cell potential is observed during the plating process. If a stepped increase in cell potential is not observed, the experiment is repeated at another chosen current density, until such stepped increase in cell potential is observed. Upon observation of a stepped increase in cell potential the electroplating process may be carried out for a sufficient time to electro-deposit a thin, uniform layer of the ternary metal onto the cathodic substrate.

### EXAMPLE 10

### Simultaneous, No External Agitation, Quaternary Plating of Copper, Indium, Gallium and Selenium

Electro-deposition of copper, indium, gallium and selenium in the proper stoichiometric ratio (CuₓIn_{y}Ga_{z}Seₙ, wherein x, y and z are 0-2 and n is 0-3) on a cathodic substrate composed of glass sputtered with Mo is carried out using 0.1-0.2 molar (M) copper ions, 00.05-0.15 M indium ions from indium chloride, 0.05-0.15 M gallium ions from gallium chloride and 0.01-0.03 M selenium ions, at least 0.3 M lithium chloride, pH 1-4 and/or other supporting electrolytes as described in Example 9 above. Plating is conducted at 24° C. with no external agitation and with the electrodes composed and arranged vertically as discussed in Example 8 and described in Example 9. A graph of cell potential over time is created to determine if a stepped increase in the cell potential is observed during the plating process. If a stepped increase in cell potential is not observed, the experiment is repeated at another, higher, chosen constant current density, until such stepped increase in cell potential is observed. Upon observation of a stepped increase in cell potential the electroplating process may be carried out to electro-deposit a thin, uniform layer of the ternary metal onto the cathodic substrate.

Although the invention is described with respect to certain preferred embodiments and certain fields of use, modifications to these embodiments that do not stray from the spirit and scope of the invention and applications not specifically mentioned will be apparent to those of skill in the art and should not be denied protection because they are not set forth herein. The examples and figures are not intended to limit the scope of the invention, but are included solely to demonstrate by way of example that the invention works for its particular purpose.

All documents referenced herein, including patents and published patent applications, inter alia, are hereby incorporated by reference for the substance of what they contain.

I claim:

1. In an electrodeposition process for electroplating at least one uniform layer of a metal on an cathodic substrate in an electroplating bath containing a suitable electroplating solution, the improvement comprising conducting the electroplating process (1) without external agitation of the electroplating solution and (2) under an effective current density or effective voltage to obtain the at least one uniform layer of a semi-conducting metal on the substrate.

2. The process according to claim 1, wherein the improvement additionally comprises disposing the cathode and anode within the bath in closely spaced-apart relation to each other and such that their longitudinal axes are disposed horizontally.

3. The process according to claim 2, wherein the cathode is positioned above the anode.

4. The process according to claim 1 wherein the cathodic substrate comprises a metal or metal alloy selected from the group consisting of titanium, molybdenum, chromium, nickel and stainless steel.

5. The process according to claim 1 wherein the electroplating solution comprises a metal or metal salt selected from the group consisting of copper, indium, nickel, gallium, tin, zinc, cadmium, tellurium, selenium, gold, silver, thallium and tungsten.

6. The process according to claim 5 wherein the current density during the process is maintained between about 0.35 and about 10.7 ASF.

7. The process according to claim 1 wherein the electroplating process is carried out with two to five different metals selected from the group consisting of copper, indium, nickel, gallium, tin, zinc, cadmium, tellurium, selenium, gold, silver, thallium and tungsten to obtain a uniform layer of a deposited alloy on the substrate.

8. The process according to claim 7 wherein the metals are copper, zinc, and tin.

9. The process according to claim 7 wherein the metals are copper, indium, gallium, and selenium.

10. The process according to claim 7 wherein the metals are cadmium and tellurium.

11. The process according to claim 7 wherein the metals are copper, indium, and selenium.

12. In an electrodeposition process for electroplating at least one metal layer on an cathodic substrate in an electroplating bath containing a suitable electroplating solution, the improvement comprising conducting the electroplating process (1) without external agitation of the electroplating solution and (2) under an effective constant current density or effective constant voltage to obtain at least one uniform layer of metal on the substrate and (3) disposing the cathodic substrate within the bath so that its longitudinal axis is disposed horizontally and the anode and the cathodic substrate and the anode are in parallel, closely spaced-apart relation to each other in the bath.

13. The process according to claim 12 wherein the electroplating solution comprises metals or metal salts of copper, zinc, and tin.

14. An article of manufacture made by the process according claims 1 or any one of claims 4 through 11.
